(19) United States
(12) Patent Application Publication
(10) Pub. No.: US 2024/0311350 A1
(43) Pub. Date: Sep. 19, 2024

(54) METHODS AND SYSTEM FOR RECOMMENDING STORAGE FORMAT FOR MIGRATING A RDBMS

(71) Applicant: HUAWEI TECHNOLOGIES CO., LTD., Shenzhen (CN)

(72) Inventors: Vishal Navnit Pandya, Bengaluru (IN); Vineet Kumar Maheshwari, Bengaluru (IN)

(73) Assignee: HUAWEI TECHNOLOGIES CO., LTD., Shenzhen (CN)

(21) Appl. No.: 18/544,049

(22) Filed: Dec. 18, 2023

Related U.S. Application Data
(63) Continuation of application No. PCT/CN2022/079412, filed on Mar. 4, 2022.

(30) Foreign Application Priority Data
Jun. 19, 2021 (IN) IN202131027515

(51) Int. Cl. G06F 16/21; G06F 16/22

(52) U.S. Cl. CPC G06F 16/214; G06F 16/213; G06F 16/221

(57) ABSTRACT

The present disclosure provides a method of recommending storage format for migrating a relational database management system (RDBMS) from a source server system to a target server system, and a system thereof. The method comprises extracting SQL queries from a source database of the source server system. Further, the method comprises parsing the SQL queries to identify a set of queries corresponding to column-based operations, identifying a number of columns (Cn) involved in the identified set of queries and for each column (C), from the number of columns (Cn), determining if values of at least a subset of column records are same. On determining that values of the at least the subset of the column records are the same, the method further comprises recommending a column storage format for the RDBMS on the target server system.

### CROSS-REFERENCE TO RELATED APPLICATIONS

This application is a continuation of International Application No. PCT/CN2022/079412, filed on Mar. 4, 2022, which claims priority to India Patent Application No. IN202131027515, filed on Jun. 19, 2021. The disclosure of the aforementioned application is hereby incorporated by reference in its entirety.

### TECHNICAL FIELD

The present disclosure described herein, in general, relates to storage formats of databases and in particular, to storage optimization and workload sequels optimization of Relational Database Management Systems (RDBMS).

### BACKGROUND

A relational database management system (RDBMS or just RDB) is a common type of database that stores data in tables, so it can be used in relation to other stored datasets. Most databases used by businesses these days are relational databases, as opposed to a flat file or a hierarchical database. The majority of current IT systems and applications are based on a relational DBMS. Relational databases have the muscle to handle multitudes of data and complex queries. The data is often stored in many tables, also called ‘relations’.

These tables are divided into rows, also called records and columns referred to as fields. There can be millions of rows in a database. Columns are made up of one data type, like name or a value. There are two ways to organize relational databases:
Row oriented, or
Column oriented (also known as columnar or C-store).

Row oriented databases are databases that organize data by record, keeping all of the data associated with a record next to each other in memory. Row oriented databases are the traditional way of organizing data and still provide some key benefits for storing data quickly. They are optimized for reading and writing rows efficiently. Common row oriented databases are Postgres™ and MySQL™.

Column oriented databases are databases that organize data by field, keeping all of the data associated with a field next to each other in memory. Columnar databases have grown in popularity and provide performance advantages to querying data. They are optimized for efficiently reading and computing on columns. Common column oriented databases are Redshift™, BigQuery™, and Snowflake™.

In order to understand the advantages and disadvantages of the row-based storage or the column-based storage, let us take an example from the following Table 1:

This data would be stored on a disk in a row oriented database, also referred to as ‘row-based storage’, in order row by row like this:

| | | | | | | | | | | | |
|---|---|---|---|---|---|---|---|---|---|---|---|
| India | Alpha | 1200 | China | Beta | 2500 | UK | Alpha | 700 | JP | Alpha | 450 |

If we want to add a new record, we can just append it to the end of the current data.

Row oriented databases are still commonly used for Online Transactional Processing (OLTP) style applications since they can manage writes to the database well. However, another use case for databases is to analyze the data within them. These Online Analytical Processing (OLAP) use cases need a database that can support ad hoc querying of the data. This is where row oriented databases are slower than C-store databases. Row oriented databases are fast at retrieving a row or a set of rows, but when performing an aggregation it brings extra data (columns) into memory, which is slower than only selecting the columns that you are performing the aggregation on. In addition, the number of disks the row oriented database might need to access is usually larger. Say we want to get the sum of sales from the Table 1 data. To do this we will need to load all twelve of pieces of data (see row-based storage format) into memory to then pull out the relevant data to do the aggregation. This is wasted computing time. To understand the number of disks accessed, let us assume a disk can only hold enough bytes of data for three columns to be stored on each disk. In a row oriented database the table above would be stored as:

Disk 1

| | | |
|---|---|---|
| India | Alpha | 1200 |

Disk 2

| | | |
|---|---|---|
| China | Beta | 2500 |

Disk 3

| | | |
|---|---|---|
| UK | Alpha | 700 |

Disk 4

| | | |
|---|---|---|
| JP | Alpha | 450 |

To get the sum of all the country sales, the computer would need to look through all four disks and across all three columns in each disk in order to make this query. So we can see that while adding data to a row oriented database is quick and easy, getting data out of it can require extra memory to be used and multiple disks to be accessed.

Data warehouses were created in order to support analyzing data. These types of databases are read optimized. In a C-Store, columnar, or column-oriented database, the data is stored such that each row of a column will be next to other rows from that same column. Let's look at the same data set of Table 1 again and see how it would be stored in a column oriented database also referred to as ‘column-based storage’ or ‘C-store’:

| | | | | | | | | | | | |
|---|---|---|---|---|---|---|---|---|---|---|---|
| India | China | UK | JP | Alpha | Beta | Alpha | Alpha | 1200 | 2500 | 700 | 450 |

If we want to add a new record, we have to navigate around the data to plug each column in to where it should be.

If the data was stored on a single disk, it would have the same extra memory problem as a row oriented database, since it would need to bring everything into memory. However, column oriented databases will have significant benefits when stored on separate disks. If we placed the table above into the restricted four columns of a data disk, they would be stored like this:

Disk 1

| | | | |
|---|---|---|---|
| India | China | UK | JP |

Disk 2

| | | | |
|---|---|---|---|
| Alpha | Beta | Alpha | Alpha |

Disk 3

| | | | |
|---|---|---|---|
| 1200 | 2500 | 700 | 450 |

To get the sum of the country sales the computer only needs to go to one disk (Disk 3) and sum all the values inside of it. No extra memory needs to be pulled in, and it accesses a minimal number of disks. While this is a slight over-simplification, it illustrates that by organizing data by column the number of disks that will need to be visited will be reduced, and the amount of extra data that has to be held in memory is minimized. This greatly increases the overall speed of the computation. There are other ways in which a column oriented database can get more performance. Also, if each piece of data is the same number of bits long, then all of the data can be further compressed to be the number of pieces of data times that number of bits for a single piece of data. Imagine a table with a million rows. Most of the columns would have only a few hundred or thousand at most of unique values. Compression makes sure you save disk space and indexing makes sure you find things faster. This optimizes storage costs in the cloud for the customer. Thus, row storage format versus column storage format can be summarized as:

| Attribute | Row Store | Column Store |
|---|---|---|
| Memory usage | Higher | Lower |
| Transactions | Faster | Slower |
| Analytics | Slower even if indexed | Faster |

In the current market trends, cloud database adoption is on the rise. One of the key opportunity areas for database vendors as part of this trend is the migration of on-premises databases to cloud databases. As well, there has been a rise of specialized database management systems like key-value (KV) stores, document stores, and time-series and graph databases apart from the traditional relational database systems. Each of these specialized database systems provide solutions to a specific problem domain and have specific use cases. These specialized database management systems solve a problem of large volume of data and increase in the rise of data sources (IOT, web logs etc.) which are not necessarily transactional in nature and are termed big data sources.

The relational database vendors have adapted to this by introducing capabilities of processing these kinds of data, as well as adapting to their storage needs for efficient data retrieval. Database systems with these capabilities are now called multi-modal database systems. A multi-modal database is designed to support multiple data models against a single, integrated backend. Document, graph, relational, and key-value models are examples of data models that may be supported by a multi-modal database. More so, they help query the different kind of these data models with the highly matured SQL. Cloud vendors already provide support for these kinds of specialized and multi-modal database systems as part of their solutions (for e.g., DBaaS). The business reason is the rise in cloud adoption of cloud database systems catering to various and specific needs of a customer, in particular their database migration and application migration needs.

Database migration is non-trivial activity and needs to be carefully planned. Typical database migration flow involves:
Schema Migration
Data Migration
Application Migration

FIG. 1 depicts the migration from a source database to a target database. It also involves the below process steps:
1. Source Schema and Data Assessment
   Data mapping, poorly populated fields, objects/fields to drop, inaccuracies etc.
2. Migration Design and Definition
   All at once or in phases
3. Migration Solution
   Develop the solution
4. Test
   Test the migration design with real data
5. Production
6. Audit
   Ensure accuracy of the migration

In the current technology, referring to FIG. 1, schema and database migration are performed through the following methods:
1. Schema conversion of source database structure to a selected target database structure
   The conversion mechanisms are either regex-based or grammar-based.
   In a parser based method, source structure is extracted into a Data model, which is then used to form the target database syntax.
2. One or multiple application queries (if required) are also converted to be compatible with the selected target database system, this as part of the application migration.
3. First schema conversion/migration is performed, followed by application migration or conversion of workload queries.

The technical problem identified in the existing solutions for schema migrations involve at least the following:
1. There is no recommendation method available specifically when considering migrating to a cloud database system which is different from the source system as well as a different processing engine and storage engine or storage formats (row storage format versus column storage format), multi-modal database.
2. None of the existing solution describes recommending a row store/column store or storing data which is compatible with specialized database systems, e.g., multi-modal, for performance considerations.
3. The current source system would have evolved over the years and the current performance may not be well suited for the target database or application queries that are going to run on the target.
4. The conversions are mostly 1:1 without taking into account query optimization and storage optimizations.

Hence, recommendations are needed at all levels when migrating from a source to a target system, and at the storage level of the data.

### SUMMARY

This summary is provided to introduce concepts related to recommending storage formats for a relational database management systems (RDBMS) when migrating from a source server system to a target server system.

A main objective of the present disclosure is to provide recommendation of storage format for migrating a relational database management system (RDBMS) from a source server system to a target server system. In order to achieve the main object, the workload queries of applications using the RDBMS at the source server system are analyzed. Also, the Data Definitional Language (DDLs) of the source objects may be analyzed. Based on the analysis of the workload queries or at least a set of the workload queries, as well as the DDLS, recommendation is provided for the storage format, i.e., a column-based storage (C-storage), or a row-based storage, when the tables of the RDBMS are to be migrated from a source server system to a target server system. In addition to the storage format of the tables of the RDBMS, additional recommendation may also be provided for a storage model of the database, for example, a multi-modal RDBMS, or a pure Time-Series model, a Key-Value (KV model) or a graph model in the target RDBMS. One of the many technical advantages of the solutions disclosed in the present embodiments is that performance of select queries can be improved when migrated to a target server system, depending upon the capabilities of the target server system. For example, by recommending a column storage (CS) format at the target, while the RDBMS table at the source only supports a row storage (RS) format, the performance can be improved, as well as optimizing resource usage. Moreover, high compression rates can be achieved by recommending C-storage in some cases, such as when the columns involved in workload queries and DDLs include only a few distinct values.

In a first implementation, the present disclosure provides a method of recommending a storage format for migrating a relational database management system (RDBMS) from a source server system to a target server system. The method comprises extracting SQL queries from a source database of the source server system. Further, the method comprises parsing the SQL queries to identify a set of queries corresponding to column-based operations, identifying a number of columns (Cn) involved in the identified set of queries and for each column (C), from the number of columns (Cn), determining if values of at least a subset of column records are the same. On determining that values of the at least the subset of the column records are the same, the method further comprises recommending a column storage (CS) format for the RDBMS on the target server system.

In a second implementation, a system for recommending storage format for migrating a relational database management system (RDBMS) from a source server system to a target server system is disclosed. The system comprises a source server system, a target server system, and a recommendation platform. The source server system comprises at least a source database of a RDBMS at the source server system, the target server system comprises a data store corresponding to one or more storage formats for a RDBMS at the target server system, and the recommendation platform comprises a first interface configured to interface with the source database of the source server system and a second interface configured to interface with the target server system. Further, the recommendation platform comprises a SQL parser and a recommendation engine. The SQL parser is configured to extract SQL queries from the source database of the source server system via the first interface, parse the SQL queries to identify a set of queries corresponding to column-based operations, and the recommendation engine is configured to identify a number of columns (Cn) involved in the identified set of queries, for each column (C) from the number of columns (Cn), determine if values of at least a subset of column records are same; and on determining that values of the at least the subset of the column records are the same, recommend a column storage (CS) format for the RDBMS on the target server system.

### BRIEF DESCRIPTION OF THE ACCOMPANYING DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a typical database migration process of a RDBMS from a source server system to a target server system.

FIG. 2 is a representation of a schema migration flow in accordance with the present disclosure.

FIG. 3 illustrates a method of recommending a storage format in accordance with the present disclosure.

FIG. 4 is a representation of a recommendation flow adopted by a recommendation engine in accordance with the present disclosure.

FIG. 5 illustrates a system for recommending a storage format in accordance with the present disclosure.

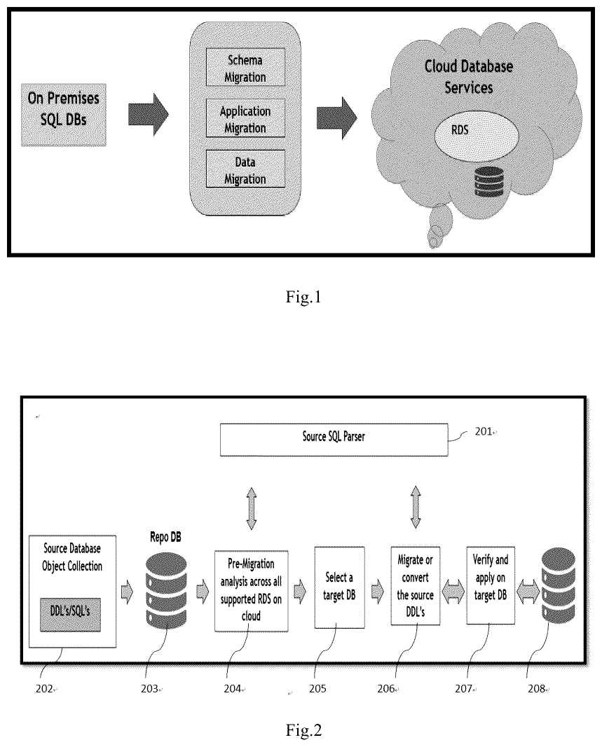

It is to be understood that the attached drawings are for purposes of illustrating the concepts of the invention and should not be construed as a limitation to the disclosure.

### DETAILED DESCRIPTION OF THE PRESENT DISCLOSURE

The following clearly describes the technical solutions in the embodiments of the present disclosure with reference to the accompanying drawings in the embodiments of the present disclosure. The described embodiments are merely a part rather than all of the embodiments of the present disclosure.

The embodiments can be implemented in numerous ways, as a process, an apparatus, a system, a composition of matter, a computer readable medium such as a computer readable storage medium or a computer network, wherein program instructions are sent over optical or electronic communication links. In this specification, these implementations or any other form that the invention may take, may be referred to as techniques. In general, the order of the steps of disclosed processes may be altered within the scope of the disclosure.

A detailed description of one or more embodiments is provided below along with accompanying figures that illustrate the principles of the embodiments. The scope of the disclosure is not limited to any embodiment. The scope of the embodiments is limited only by the claims and the disclosure encompasses numerous alternatives, modifications, and equivalents. Numerous details are set forth in the following description in order to provide a thorough understanding. These details are provided for the purpose of example and the disclosed embodiments may be practiced according to the claims without some or all of these details. For the purpose of clarity, technical material that is known in the technical fields related to the disclosure has not been described in detail so that the disclosure is not unnecessarily obscured.

In the following detailed description, numerous details are set forth in order to provide a thorough understanding of the disclosed embodiments. However, it will be understood by those skilled in the art that the present disclosure may be practiced without these details. In other instances, well-known methods, procedures, and components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, “extracting”, “parsing”, “recommending” or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

The present disclosure proposes recommending a storage format, and additionally also recommending a storage model on the target database for the source objects by analyzing the workload queries and the Data Definition Language (DDLs). The idea is core to the schema migration step of a typical migration solution from on-premises RDBMS at the source server system to a RDBMS at the target server system. In one embodiment, the target server system is a cloud based target. In a further embodiment, the RDBMS at the cloud may be a multi-modal RDBMS. However, in some embodiments, the target server system may include a database model that is purely a KV store, or a time-series model, or a graph model as well. According to an implementation of the present disclosure, the RDBMS at the target server system supports both the column-based storage as well as the row-based storage. In one such implementation, the RDBMS at the target server system supports a hybrid storage format. A hybrid database table is stored as both a row and a column store. In another such implementation, the RDBMS at the target server system supports row storage format and column storage formats separately, i.e. a RDBMS table at the target server system may only supports row storage format and another RDBMS table at the target server system may only support column storage format.

The data storage format used over the years in a typical RDMBS is essentially row-based. Over the years, organizations would have added multiple applications/queries and changes to database logical schema with RDBMS column storage options, which is essentially a row-based storage format. As well, if the current model/DBMS is a pure KV store model/time series model, the same can be analyzed to propose a row store, column store model in the target database.

Prior art solutions fail to take into account the possibilities for recommending storage, partitioning, and multi-modal options, which most current known vendors of RDBMS support in the cloud. The present disclosure improves upon the prior art by recommending row or column storage format when considering migrating RDBMS tables of the source target system to a target server system. The extension to the proposed technical solution also recommends a specialized data model storage (i.e., a KV, time series, graph, etc.), depending upon the capabilities of the target server system.

By way of an example, FIG. 2 is a representation of a schema migration flow in the present disclosure. A recommendation platform, which may be third party vendor or an in-house solution, accesses the storage or the source database objection collection of the source database, performs analysis and post recommendation and approval of a target database, selects a target database, converts the DDLs according to the compatibility of the target database, if required, and executes schema migration from the source database to the target database. As shown in FIG. 2, the source SQL parser at 201 is involved in extracting and parsing the SQLs (Structured Query Language)/workload queries, and DDLs from the source database objection collection 202 of the source database from the source server system. The extracted and parsed data is usually stored by the source SQL parser 201 in a repository database (Repo DB) 203 of the recommendation platform where it is analyzed by a recommendation engine (not shown in FIG. 2), based on various factors discussed later. The recommendation engine at 204 performs all the pre-migration analysis on the SQLs/DDLs across all the supported RDBMS (referred to as ‘RDS’) on the target server system such as on cloud. The recommendation engine at 205 selects a target DB. As part of a typical migration process, the queries/DDLs involved at the source may be converted at 206 to make it compatible with the new database structure at the target server system. At 207 the conversions are verified and applied on the target database and migrated to the target database 208 eventually.

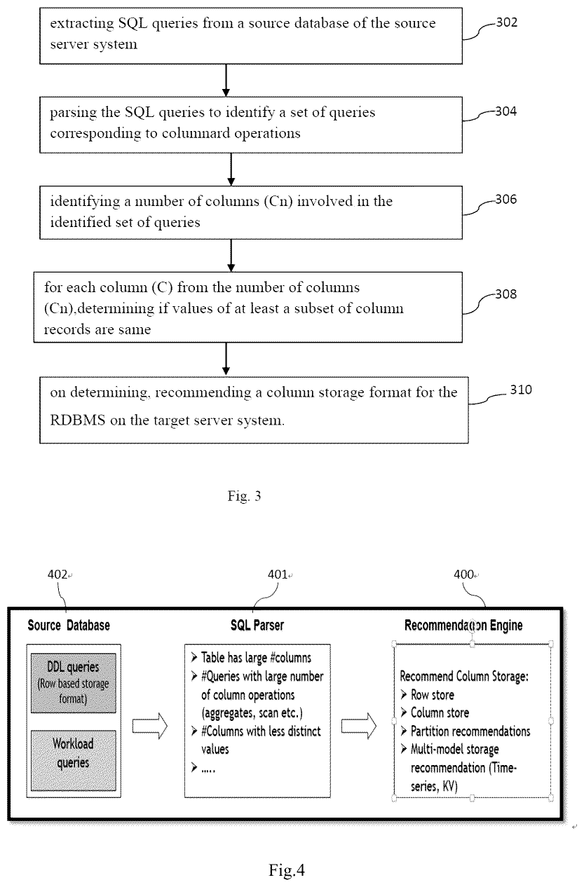

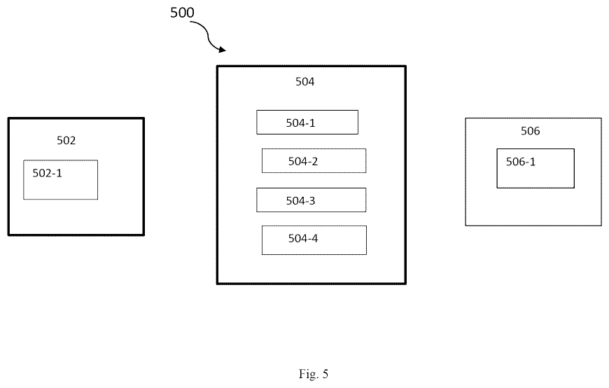

Reference is now made to FIG. 3, a method of recommending storage format for migrating a relational database management system (RDBMS) from a source server system to a target server system, is disclosed in accordance with an embodiment. In one implementation, the method is performed at a recommendation platform which can access the source database object collection at the source server system. The source system hosts the RDBMS tables at the source which are intended to be migrated to a target server system. In such implementation, the recommendation platform may be hosted at a third party server remotely located from the source server system and in communication with the source server system. In another such implementation, the recommendation platform may be hosted at the source server system. The storage format as discussed above includes at least one of a row storage format or a column storage format. By way of an example, the storage format recommended for the RDBMS tables migrated to the target server system may only be a column storage format. In another example, the storage format recommended for the RDBMS tables migrated to the target server system may only be a row storage format. In yet another example, the storage format recommended for a migrated RDBMS table may include column storage for at least subset of columns from that RDBMS table and may include row storage for other columns from the same RDBMS table. These decisions depend upon factors which can be understood from the foregoing discussions as well as some of the scenarios/use cases discussed in this application.

By way of examples, a column-based store is recommended in the scenarios which may include, but not limited to:
CASE A: Calculations are typically executed on individual or a small number of columns.
CASE B: The table is searched based on the values of a few columns.
CASE C: The table has a large number of columns.
CASE D: The table has a large number of rows and columnar operations are required (for e.g., aggregate, scan, and so on)
CASE E: High compression rates can be achieved because the majority of the columns contain only a few distinct values (compared to the number of rows).

By way of examples, a row-based store is recommended in the scenarios which may include, but not limited to:
CASE F: The application needs to process only a single record at a time (many selects and/or updates of single records).
CASE G: The application typically needs to access the complete record.
CASE H: The columns contain mainly distinct values so compression rate would be low.
CASE I: Neither aggregations nor fast searching are required.
CASE J: The table has a small number of rows (for example, configuration tables).

The above examples should not be construed as limitations, as other scenarios may also emerge depending upon each case and from the applications' usage perspective. The recommendation method may consider one or more of the above cases to recommend the storage formats.

Further, in accordance with the embodiments of the disclosure, additional factors in conjunction with the above listed cases may be considered before recommending a storage format. By way of examples, the additional factors according to some of the implementations may include, but not limited to:
1. Table has a large number of columns (C) and/or are typically involved in queries with below factors or Table has large number of columns which involve only in queries with below factors.
2. Number of Queries (Q) with large number of columnar operations (such as, aggregates, scan etc.).
3. Columns (C) with less distinct values.

In an embodiment, the number of columns considered for recommending a storage format are in relation to a number of queries (e.g., SQL, DDLs) being analyzed for the recommendation. As an example, out of 50 queries, if only 20 queries are found using columnar operations involving columns of a table, then the optimization level of the queries is not achieved and column-based storage may not be recommended even when the number of columns are higher in those 20 queries. However, if out of 500 queries, 200+ are involved in columnar operations, the column-based storage may be considered after looking into the number of columns involved in those 200+ queries and/or the unique values in such columns. This is because in the latter case, a relatively higher number of queries are being optimized and consequently, the storage optimization can be achieved.

In accordance with a further embodiment, the method of recommending a storage format may comprise recommending column-based storage for at least a subset of columns of a table of the source RDBMS. In this case, the subset of columns may be those which are involved in the queries involving columnar operations. Such number of columns may be high and/or each of these columns may include a smaller number of unique values. In addition, the method of recommending a storage format may further comprise recommending row-based storage for the columns other than the subset of columns for which column-based storage has been recommended. In an implementation, the row storage format is recommended for records of other columns not involved in the identified set of queries corresponding to columnar operations. Thus, for the same RDBMS table at the source server system, column-based storage may be recommended for some columns, while for the other columns row-based storage is still recommended. In one such implementation, the target RDBMS may be a hybrid database that supports hybrid storage format, i.e., both column storage format and row storage format. Based on the recommendation that both column-based storage and row-based can be supported at the target server system, the source RDBMS table may be recreated at the target server system upon migration from the source server system. If however, the target RDBMS supports row storage format separately and column storage format separately, i.e., the target RDBMS is not a hybrid database and yet supports both storage formats, then based on the recommendation that both column-based storage and row-based can be supported at the target server system, the source RDBMS table may be split into two tables at the target server system upon migration.

Referring back to FIG. 3, the method of recommending a storage format comprises, at step 302, extracting SQL queries from a source database of the source server system. SQL (Structured Query Language) is a language for database management. All the RDBMS systems like MySQL™, MS Access, Oracle™, Sybase, Postgres™, and SQL Server™ use SQL as their standard database language. SQL programming language uses various commands for different operations. Some of these commands forming the SQL queries involve (1) DDL (Data Definition Language), for e.g., CREATE, ALTER, DROP, (2) DML (Data Manipulation Language), for e.g., INSERT, UPDATE, DELETE, (3) DQL (Data Query Language, for e.g., SELECT. The SELECT command helps to select the attribute based on the condition described by the WHERE clause. By way of an example, the SYNTAX for the SELECT command is:

SELECT expressions
FROM TABLES
WHERE conditions;
Example:
SELECT First Name
FROM Student
WHERE Roll No > 15;

Often the SELECT queries may be used with SQL aggregate functions. We often use aggregate functions with the GROUP BY and HAVING clauses of the SELECT statement. The following are the most commonly used SQL aggregate functions:
AVG—calculates the average of a set of values.
COUNT—counts rows in a specified table or view.
MIN—gets the minimum value in a set of values.
MAX—gets the maximum value in a set of values.
SUM—calculates the sum of values.

As a first step, the workload queries comprising the SQL queries, some of the examples explained above, are extracted from the historical SQL logs, table statistics from a source database of the source server system hosting the source RDBMS. This could be understood as extracting the DDLs/SQLs from the source database object collection at step 202 shown in FIG. 2.

Referring back to FIG. 3, the method at step 304 comprises parsing the SQL queries to identify a set of queries corresponding to columnar operations. The columnar operation herein may refer to SELECT workload queries that may further comprise the aggregate functions. Basically, those SQL queries which provides several aggregate functions for making calculations based on columns, for example, AVG, MAX/MIN, SUM, and COUNT, are termed columnar operations in the context of the present disclosure. By way of example, the columnar operations may include SYNTAX such as:

```
SELECT MAX(price) as “_”
  FROM “column x”;
SELECT AVG(year)
  FROM “column y”;
SELECT SUM(price) AS “ ”
  FROM “column x”;
```

From the hundreds of SQL queries extracted at step 302, the contents of each query is parsed.

Referring to the example shown in FIG. 2, it may be understood as the step where it is discussed that the extracted data and parsed is usually stored by the source SQL parser 201 in a repository database (Repo DB) 203 of a recommendation platform. The contents of each query is parsed into a metadata model (either in-memory or persisted), which establishes for each query the projection list, predicates, aggregate functions used, joins, WHERE clauses, and the columns involved etc. The in-memory or persistent storage where the metadata model is created and stored is of a recommendation platform implementing the method 300. In summary, at this step, the method takes into consideration the workload query as the input and determines whether the different clauses in the query have table columns which are involved in aggregate operations, range expressions, average operations etc.,

At step 306, the method shown in FIG. 3 further comprises identifying a number of columns, which is also designated as “Cn” in the description. The information extracted and parsed in steps 302 and 304 are analyzed to identify the number of columns involved in the columnar operations. A high number of columns in a relatively larger number of SQL queries may become one of the factors for the recommendation platform to recommend a C-store for those columns of the source RDBMS upon migrating to the target RDBMS. In a continuation step 308, for each column (C) from the number of columns (Cn), the method further comprises determining if values of at least a subset of column records, also referred to as ‘#records’ are the same. In addition to the number of columns, the recommendation method also takes into consideration the number of column records (#records) and the number of unique vales (#unique values) of each column (C) in the table. More usage statistics can be taken into account regarding the table statistics like for the indexes defined. However, these statistics do not restrict the scope of the present method. The steps 306 and 308 define the core idea of the disclosure where the number of columns, in relation to the volume of SQL queries involving columnar operations, and additionally factors like #records and #unique values are analyzed and determined to recommend a storage format when a RDBMS table is to be migrated to a target RDBMS.

At step 310, the method shown in FIG. 3 comprises recommending a column storage format for the RDBMS on the target server system. The recommendation is based on the determining step 308 which is in continuation to step 306. With the factors Cn and #records, #unique values, the column-based storage may be recommended in consideration of case scenarios, CASE A to CASE E, discussed by way of examples above.

In accordance with a further embodiment, the column storage format is recommended, as illustrated in FIG. 3, when the subset of column records of the column (C), which has unique values, comprises at least 70-80% of the column records of the column (C).

In accordance with a further embodiment, the column storage format is recommended, as illustrated in FIG. 3, when the number of columns (Cn) involved in the identified set of queries is in a range of 30-70% of the actual number of columns.

In accordance with a further embodiment, the column storage format is recommended, as illustrated in FIG. 3, when the set of queries, i.e., the workload queries/SQL queries corresponding to columnar operations comprises at least 50-70% of the SQL queries extracted from the source database of the source server system.

In accordance with an embodiment, the column storage format is recommended for the RDBMS on the target server system only for the columns (C) from the number of columns (Cn) involved in the identified set of queries. That being said, in an implementation it is possible that while the column storage format is recommended for some number of columns (Cn), for the other columns row-based storage format may still be recommended. As explained above, this feature can be implemented in two ways at the target RDBMS. On the target, if a hybrid of row and column formats is supported, then the same table, i.e., the source RDBMS table, can be recreated at the target RDBMS. Else the table (i.e., the source RDBMS table), may need to be split into two or more tables on the target to support both row and column formats. It is understood that the RDBMS at the target source system still has to support both the row format and the column format. This idea can also be thought to be extended to recommend column partitions as well on the target, based on its usage in the workload queries, as well recommend a time-series model of storing and processing queries specific to the target database.

In an alternate embodiment, the method may comprise recommending a row storage format for the RDBMS on the target server system if the factors for the column-based storage may not be achieved. By way of an example, if at step 308 at FIG. 3, for each column (C) from the number of columns (Cn), the method comprises determining if values of at least a subset of column records are distinct, then at step 310 the method may comprise recommending a row storage format for the RDBMS on the target server system. Herein, the subset of column records of the column (C), which has distinct values, comprises at least 50-70% of the column records of the column (C). By way of another example, if at step 308 at FIG. 3, for each column C, or any column C from the number of columns (Cn), if the subset of column records (including unique values) is less than a range of 70-80% of the column records of the column (C), the row storage format may be more suitable for those columns of the table. Thus, the method may comprise recommending a row storage format for the RDBMS on the target server system if the subset of column records of the column (C) (with unique values) comprises less than 70-80% of the column records of the column (C). In yet another example, the method may comprise recommending a row storage format for the RDBMS on the target server system if the number of columns (Cn) involved in the identified set of SQL queries (e.g., at step 306 in FIG. 3) is less than a range of 30-70% of the actual number of columns of the table. In summary, if a few columns are involved in columnar operations in relation to the number of SQL queries extracted and parsed, and/or if the values of a majority column records are distinct, or in other words the number of unique values of the column records of the columns involved are few, then a row-based storage format may actually be more suitable for those column records at the target. With the factors Cn and #records, #unique values, the row-based storage may be recommended in consideration of case scenarios, such as CASE F to CASE J, discussed by way of examples above.

In accordance with further embodiments of the disclosure, the methods of recommendation for migrating tables of a source RDBMS to a target RDBMS may be extended to recommend a storage model on the target server system. While analyzing the SQL queries of the source RDBMS, it may be found that a relatively higher volume of workload queries are suitable for a time-series model, a KV model, or a multi-modal formats. In one such possibility, the workload queries may have conditions which are time range based for partition recommendations or a time series data mode on a multi-modal target database in the cloud. Thus, the methods of recommendation storage formats for migrating from a source RDBMS to a target RDBMS may further comprise recommending a multi-modal storage for the RDBMS on the target server system. The multi-modal storage may be at least one of a time-series model or a KV model.

According to embodiments of the present disclosure, a system is disclosed for recommending a storage format for migration of a relational database management system (RDBMS) from a source server system to a target server system. The system broadly comprises at least a source server system hosting the RDBMS tables to be migrated, a target server system to which the RDBMS tables are migrated to, and a recommendation platform in communication with the source server system and the target server system. While FIG. 2 depicts the migration flow from the source server system to the target server system, the migration flow involving analysis of the parsed SQL queries from the source database objection collection, FIG. 4 depicts the recommendation flow adopted by a recommendation engine in the present disclosure, the recommendation engine being a part of the recommendation platform and being the core part of the storage recommendation solution disclosed in the present disclosure. In FIG. 4, the source database 402 may be considered as the source database object collection of the source server system also shown in FIG. 2. The source database 402 comprises the SQL queries/DDLs/workload queries. Further, as shown in FIG. 4, the SQL parser 401, also understood as the SQL parser 201 shown in FIG. 2, extracts and parses the SQLs (Structured Query Language)/workload queries, and DDLs from the source database objection collection 402 from the source database of the source server system. The extracted data and parsed is usually stored by the source SQL parser 201 in a repository database (for e.g., Repo DB 203) of the recommendation platform where it is analyzed by a recommendation engine 400. The SQL parser 401 and the recommendation engine 400 form part of the recommendation platform which is in communication with the source server system and the target server system through respective communication interfaces. The recommendation platform which may be third party vendor or an in-house solution accesses the storage or the source database objection collection of the source database, performs analysis and post-migration provides recommendation and/or approval of a target database based on the analysis. The migration flows are represented by FIGS. 2 and 4. In accordance with the teachings of the present disclosure, the recommendation engine 400 analyzes the information extracted by the SQL parser 401 to determine the number of columns (#columns), the number of queries (#queries) involved in columnar operations, the number of columns (#columns), with less distinct values, etc., based on which the recommendation engine 400 recommends column-based storage for the records of the table at the target. Alternatively, the recommendation engine 400 may opt for row-based storage format, partition recommendations, i.e., splitting of table to support separately row-based storage format or column-based storage format. In addition, the recommendation engine 400 may also recommend storage model for the migrated tables at the target, the storage model which may include, for example, a multi-modal storage (times series, KV model), a pure time-series model, or a pure KV model.

Reference is now made to FIG. 5, which depicts a system for recommending storage format for migration of a relational database management system (RDBMS) from a source server system to a target server system, in accordance with an embodiment of the disclosure. In FIG. 5, the system 500 comprises a source server system 502 comprising at least a source database 502-1 of a RDBMS at the source server system. The RDBMS at the source server system has also been referred to a source RDBMS throughout the disclosure. The source database, or a source database object collection (see FIG. 2 and FIG. 4) comprises the SQL queries/DDLs/workload queries. Further, the system 500 comprises a target server system 506, which may comprise a data store 506-1 corresponding to one or more storage formats for a RDBMS at the target server system 506. The RDBMS at the target server system has also been referred to a target RDBMS throughout the disclosure. The target server system maybe a target that is recommended out of the several targets known to the recommendation platform engaged as a migration solution provider for the source RDBMS. One of the several examples of the target may include cloud services. Each target may have specific configurations suitable to the applications that will be run and supported by the target. In implementations of the present disclosure, the target supports the column storage format for the RDBMS tables. In this context, the data store 506-1 of the target server system is either a hybrid data store, or at least supports both column storage and row storage where the source RDBMS tables have to be split according to the storage format at the target. In additional implementations, the data store may also support a multi-modal storage format, KV model, time series model, etc. Further, the system 500 comprises a recommendation platform 504 which is configured to interface with the source database system 502 and interface with the target server system 506, and is configured to provide recommendation of the storage format of the source RDBMS tables at the target server system, upon migration, in accordance with the embodiments of the present disclosure. In additional implementation, the recommendation platform may be further configured to recommend a storage model of the source RDBMS tables at the target server system, upon migration. As specified in the disclosure, the storage models include, but are not limited to, a multi-modal database, a pure KV store, a pure time-series store, etc.

In order to implement the recommendation solutions of the present disclosure, the recommendation platform 504, referring to FIG. 5, comprises a first interface 504-1 configured to interface with the source database 504-1 of the source server system 502 and a second interface 504-2 configured to interface with the target server system 506. The first interface 504-1 and the second interface 504-2 may be understood as communication interfaces and/or database connectivity interfaces and/or programming interfaces and/or data access interfaces that allow the recommendation platform to have access to the SQLs/workload queries at the source database 502-1, as well as access information of the data store 506-1 and the configurations/applications supported at the target server system 506. Further, the recommendation platform 504 comprises a SQL parser 504-3 and a recommendation engine 504-4. It should be understood that the recommendation platform performs the above disclose method illustrated in FIG. 3 employing the SQL parser 504-3 and the recommendation engine 504-4. While the SQL parser 504-3 includes the SQL parser 401 shown in FIG. 4 and source SQL parser 201 shown in FIG. 2, the recommendation engine 504-4 includes the recommendation engine 400 shown in FIG. 4. The recommendation engine 400 is also involved in the migration flow steps 204-207 shown in FIG. 2

In accordance with an embodiment, the SQL parser 504-3 is configured to extract SQL queries from the source database 502-1 of the source server system 502 via the first interface 504-1 and is further configured to parse the SQL queries/workload queries to identify a set of queries corresponding to columnar operations. The recommendation platform may also include a repository database, refer to FIG. 2, where all the extracted queries are stored for analysis. Further, the recommendation engine is configured to identify a number of columns (Cn) involved in the identified set of queries corresponding to columnar operations, for each column (C) from the number of columns (Cn), the recommendation engine 504-4 is configured to determine if values of at least a subset of column records are the same, and on determining that the values of the at least the subset of the column records are the same, recommend a column storage format for the RDBMS on the target server system.

In accordance with the embodiments, the recommendation engine 504-4 is configured to recommend column-based store in the scenarios which may include, but not limited to, CASE A to CASE E, described in this application.

In accordance with the embodiments, the recommendation engine 504-4 is configured to recommend a row-based store in the scenarios which may include, but not limited to, CASE F to CASE J, described in this application.

In accordance with a further embodiment, the column storage format is recommended by the recommendation engine 504-4, when the subset of column records of the column (C), which has unique values, comprises at least 70-80% of the column records of the column (C). In accordance with a further embodiment, the column storage format is recommended by the recommendation engine 504-4 when the number of column (Cn) involved in the identified set of queries is in a range of 30-70% of the actual number of columns. In accordance with a further embodiment, the column storage format is recommended by the recommendation engine 504-4, when the set of queries, i.e., the workload queries/SQL queries corresponding to columnar operations, comprises at least 50-70% of the SQL queries extracted from the source database of the source server system. In accordance with an embodiment, the column storage format is recommended for the RDBMS on the target server system by the recommendation engine 504-4, only for the columns (C) from the number of columns (Cn) involved in the identified set of queries. That being said, in an implementation it is possible that while the column storage format is recommended for some number of columns, Cn. For the other columns row-based storage format may still be recommended and applicable at the target RDBMS.

In alternate embodiments, a row storage format for the RDBMS on the target server system is recommended by the recommendation engine 504-4 if the factors for the column-based storage may not be achieved. By way of an example, if at step 308 at FIG. 3, for each column (C) from the number of columns (Cn), the method comprises determining if values of at least a subset of column records are distinct, then at step 310, the method may comprise recommending a row storage format for the RDBMS on the target server system. Herein, the subset of column records of the column (C), which has distinct values, comprises at least 50-70% of the column records of the column (C). By way of another example, the recommendation engine is configured to, for each column (C) from the number of columns (Cn) involved in the columnar operations, determine if values of subset of the column records are distinct. Accordingly, the recommendation engine is configured to recommend a row storage format for the RDBMS on the target server system. Alternatively, for each column C, or any column C from the number of columns (Cn) involved in the columnar operations, if the subset of column records including unique values is less than a range of 70-80% of the column records of the column (C), the row storage format may be more suitable for those columns of the table. Thus, the recommendation engine 504-4 may recommend a row storage format for the RDBMS on the target server system if the subset of column records of the column (C) (with unique values) comprises less than 70-80% of the column records of the column (C). In yet another example, the if the number of column (Cn) involved in the identified set of SQL queries is less than a range of 30-70% of the actual number of columns of the table, the recommendation engine 504-4 may recommend a row storage format for the RDBMS on the target server system.

In accordance with the disclosed embodiments, the data store 506-1 of the target server system 506 supports hybrid storage format for the RDBMS, accordingly on recommendation of C-store for a source RDBMS tables to be migrated to the target. The recommendation engine 504-4 is further configured to recommend recreating the table at the target server system. Alternatively, if the data store 506-1 does not support a hybrid storage format, the recommendation engine 504-4 is further configured to split the table at the target server system.

In accordance with the additional embodiments, the teaching of the present disclosure is extended to enable the recommendation engine 504-4 to recommend a multi-modal storage for the RDBMS on the target server system. The multi-modal storage may include a time-series model or a KV model.

In the present disclosure, the source server system and the target server system may be understood as having an architecture of RDBMS client-server systems. The source server system may be a server and the client may be an application accessing the source server. Similar analogy can be applied to the target server system. The source server system may also be referred to as a source server, or a server device at the source, in context that the RDBMS tables are to be migrated from the source. Similarly, the target server system may also be referred to as a target server, or a server device at the target, in context that the RDBMS tables are to be migrated to the target. The recommendation platform may also be understood as a computing device, or a server of a client-server architecture implementing as a client to the source server system and as a server to the target server system respectively, as the case may be. One skilled in the art will recognize that the terms ‘server’, ‘computing device’ is used herein for purposes of clarity of discussion of the architecture, but is in no way meant to limit the application of the present disclosure to a particular computer/server. At least some of the features/methods described in the disclosure are implemented in a computing device as are commendation platform comprising communication interfaces, SQL parser and a recommendation engine. The components of the recommendation engine, SQL parser and interfaces in the disclosure are implemented, for instance, using hardware, firmware, and/or software installed to run on hardware. The computing device may comprise transceivers, which are transmitters, receivers, or combinations thereof. A processor may be included in the computing device to process the information-workload queries-extracted and parsed from another server-source. The processor may comprise one or more multi-core processors and/or memory modules. Processor is implemented as a general processor or is part of one or more application-specific integrated circuits (ASICs) and/or digital signal processors (DSPs). It is understood that by programming and/or loading executable instructions onto the computing node, at least one of the processor, and the long-term storage are changed, transforming the computing node in part into a particular machine or apparatus, e.g., provide storage format recommendation solutions for migrating source RDBMS to a target RDBMA as taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change is preferred to be implemented in software, because re-spinning a hardware implementation is more expensive than re-spinning a software design. Generally, a design that is stable that will be produced in large volume is preferred to be implemented in hardware, for example in an ASIC, because for large production runs the hardware implementation is less expensive than the software implementation. Often a design is developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions is viewed as a particular machine or apparatus.

The present disclosure as explained with reference to FIGS. 3, 4 and 5 provides at least the following beneficial technical effect that the workload queries may be better optimized. In addition, the following technical effects can be derived upon implementing the embodiments herein:
1. The database administrator, DBA/Cloud Administrator can better understand the differences between the existing source and selected target system on cloud.
2. Helps in saving storage costs on the cloud
3. Helps in optimizing queries to take advantage of different kinds of storage formats on the available on the target database.

It may be clearly understood by a person skilled in the art that for the purpose of convenient and brief description, for a detailed working process of the foregoing system, apparatus, and unit, reference may be made to a corresponding process in the foregoing method embodiments, and details are not described herein again.

While several embodiments have been provided in the present disclosure, it should be understood that the disclosed systems and methods might be embodied in many other forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the Scope disclosed herein.

Accordingly, the scope of protection is not limited by the description set out above, but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments is intended to be illustrative, but not limiting.

1. A method of recommending a storage format for migrating a relational database management system (RDBMS) from a source server system to a target server system, the method comprising:
extracting SQL queries from a source database of the source server system;
parsing the SQL queries to identify a set of queries corresponding to columnar operations;
identifying a number of columns (Cn) involved in the identified set of queries;
for each column (C) from the number of columns (Cn), determining if values of at least a subset of column records are the same; and
on determining that values of the at least the subset of the column records are the same, recommending a column storage (CS) format for the RDBMS on the target server system.

2. The method as claimed in claim 1, wherein the subset of column records of the each column (C) comprises at least 70-80% of the column records of the column (C).

3. The method as claimed in claim 1, wherein the number of columns (Cn) involved in the identified set of queries is in a range of 30-70% of the actual number of columns.

4. The method as claimed in claim 1, wherein the set of queries corresponding to columnar operations comprises at least 50-70% of the SQL queries extracted from the source database.

5. The method as claimed in claim 1, comprising:
for the each column (C) from the number of columns (Cn), determining if values of the subset of the column records are distinct; and
recommending a row storage (RS) format for the RDBMS on the target server system.

6. The method as claimed in claim 1, comprising recommending a row storage (RS) format for the RDBMS on the target server system if the subset of column records of the each column (C) comprises less than 70-80% of the column records of the each column (C).

7. The method as claimed in claim 1, comprising recommending a row storage (RS) format for the RDBMS on the target server system if the number of columns (Cn) involved in the identified set of queries is less than a range of 30-70% of the actual number of columns.

8. The method as claimed in claim 1, wherein the column storage (CS) format is recommended for the column records of the columns from the identified number of columns (Cn) corresponding to the columnar operations.

9. The method as claimed in claim 8, wherein the row storage (RS) format is recommended for other column records of other columns not involved in the identified set of queries corresponding to columnar operations.

10. The method as claimed in claim 8, wherein the target server system supports hybrid storage format for the RDBMS.

11. The method as claimed in claim 10, comprising recommending recreating a table at the target server system.

12. The method as claimed in claim 8, comprising recommending splitting a table at the target server system.

13. The method as claimed in claim 1, further comprising recommending a multi-modal storage for the RDBMS on the target server system.

14. The method as claimed in claim 13, wherein the multi-modal storage is at least one of a time-series model or a key-value (KV) model.

15. A system for recommending a storage format for migrating a relational database management system (RDBMS) from a source server system to a target server system, the system comprising:
a source server system comprising at least a source database of a RDBMS at the source server system;
a target server system comprising a data store corresponding to one or more storage formats for a RDBMS at the target server system;
a recommendation platform comprising:
a first interface configured to interface with the source database of the source server system;
a second interface configured to interface with the target server system;
a SQL parser; and
a recommendation engine:
the SQL parser being configured to:
extract SQL queries from the source database of the source server system via the first interface;
parse the SQL queries to identify a set of queries corresponding to columnar operations;
the recommendation engine is configured to:
identify a number of columns (Cn) involved in the identified set of queries;
for each column (C) from the number of columns (Cn), determine if values of at least a subset of column records are the same; and
on determining that values of the at least the subset of the column records are the same, recommend a column storage format for the RDBMS on the target server system.

16. The system as claimed in claim 15, wherein the subset of column records of the each column (C) comprises at least 70-80% of the column records of the column (C).

17. The system as claimed in claim 15, wherein the number of columns (Cn) involved in the identified set of queries is in a range of 30-70% of the actual number of columns.

18. The system as claimed in claim 15, wherein the set of queries corresponding to columnar operations comprises at least 50-70% of the SQL queries extracted from the source database.

19. The system as claimed in claim 15, wherein the recommendation engine is configured to:
for the each column (C) from the number of columns (Cn), determine if values of the subset of the column records are distinct; and
recommending a row storage (RS) format for the RDBMS on the target server system.

20. The system as claimed in claim 15, wherein the recommendation engine is configured to recommend a row storage (RS) format for the RDBMS on the target server system if the subset of column records of the each column (C) comprises less than 70-80% of the column records of the each column (C).
